(19) United States
(12) Patent Application Publication
(10) Pub. No.: US 2019/0184658 A1
(43) Pub. Date: Jun. 20, 2019

(54) NONPNEUMATIC TIRE ASSEMBLY METHOD AND APPARATUS

(71) Applicant: The Goodyear Tire & Rubber Company, Akron, OH (US)

(72) Inventors: Daniel Ray DOWNING, Uniontown, OH (US); James Alfred BENZING, II, North Canton, OH (US); Wesley Glen SIGLER, Barberton, OH (US); Laura Mechala CHAN, Akron, OH (US); Kenneth Wayne RUDD, Stow, OH (US); Michael Thomas DRISCOLL, Norton, OH (US)

(21) Appl. No.: 15/844,799

(22) Filed: Dec. 18, 2017

(51) Int. Cl. B29D 30/02; B29D 30/00; B60B 9/26

(52) U.S. Cl. CPC B29D 30/02; B60B 2320/12; B60B 9/26; B29D 30/0016

(57) ABSTRACT

A method and apparatus for forming a nonpneumatic tire is described. The method includes the steps of: mounting a rim on a spindle; providing a spoke structure having an inner diameter and an outer diameter, expanding the inner diameter and mounting the spoke structure over the rim; compressing the outer diameter of the spoke structure and then mounting a tread and shearband assembly over the outer diameter to form a nonpneumatic tire.

### FIELD OF THE INVENTION

The invention relates generally to non-pneumatic tires, and more particularly to a method and apparatus for assembling a non-pneumatic tire.

### BACKGROUND OF THE INVENTION

The invention describes a method and apparatus necessary to assembly a non-pneumatic tire. A non-pneumatic tire typically comprises a tread, a shearband, a series of spokes and a rim. Generally, the spokes or connecting structures are glued to the rim and the shearband via an adhesive. Difficulty arises in mounting the rim to the inner radius of the spokes, particularly when an interference fit is utilized. Difficulty also arises when mounting the spokes to the shearband, particularly when an interference fit is required. Thus, an apparatus and method of efficiently assembling the tire components is desired.

### SUMMARY OF THE INVENTION

According to one aspect of the invention, a method for forming a nonpneumatic tire includes the steps of: mounting a rim on a spindle; providing a spoke structure having an inner diameter and an outer diameter, expanding the inner diameter and mounting the spoke structure over the rim; compressing the outer diameter of the spoke structure and then mounting a tread and shearband assembly over the outer diameter to form a nonpneumatic tire.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Radial” and “radially” means directions radially toward or away from the axis of rotation of the tire.

### BRIEF DESCRIPTION OF THE DRAWINGS

The invention will be described by way of example and with reference to the accompanying drawings in which:

FIG. 1 is a front view of a non-pneumatic tire building apparatus of the present invention;

FIG. 2 is a side view of the tire building apparatus of FIG. 1 showing the rim mounting apparatus;

FIG. 3A is a front view of the rim mounting apparatus of FIG. 2;

FIG. 3B is a close-up front view of the rim mounting apparatus shown in FIG. 2 with a plurality of mounted spokes;

FIG. 3C is a side view of FIG. 3A shown with the rim mounted inside the spokes;

FIG. 4 is a front view of a shear band and tread assembly apparatus;

FIG. 5A is a close-up view of the shear band and tread assembly apparatus with the spokes mounted therein.

FIG. 5B is a side view of FIG. 5A shown with the shear band mounted over the spokes.

FIG. 6 is a front view of the non-pneumatic tire building apparatus of the present invention shown with a rim mounted on the spindle and a shear band mounted on the shear band carriage, and the spokes mounted on the rim mounting apparatus.

FIG. 7A-7C illustrates the rim mounting assembly with the expanded spokes being manually pushed towards the shear band and tread mounting apparatus, and then mounted on the rim.

FIGS. 8A and 8B illustrate the rim mounting assembly being returned to the home position.

FIG. 9 illustrates the shear band and tread mounting apparatus with the pins in the contracted position.

FIG. 10A illustrates the shear band and tread being installed over the collapsed spoke assembly, while FIG. 10B illustrates a front view of the collapsed spoke assembly with the shear band installed over the spokes.

### DETAILED DESCRIPTION OF THE INVENTION

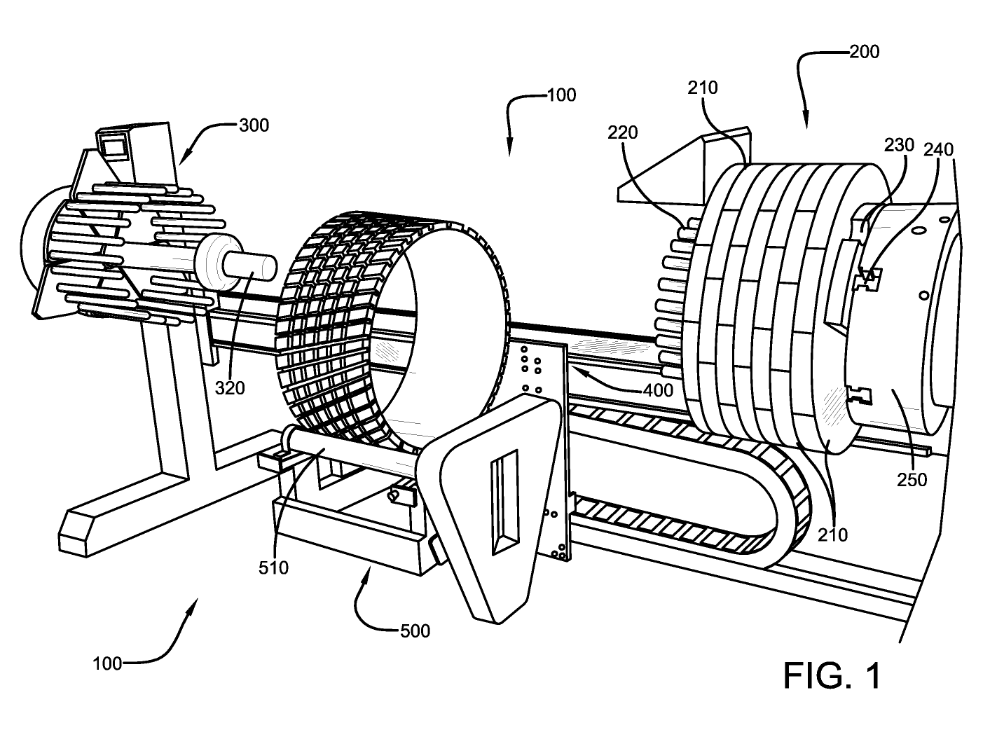

Referring to FIG. 1, a nonpneumatic tire building apparatus 100 is shown. The nonpneumatic tire includes a shear band and tread, a spoke or connecting web structure, and a rim. The non-pneumatic apparatus includes a rim mounting apparatus 200 for mounting the one or more connecting structures onto a tire rim. The nonpneumatic tire building apparatus further includes a shear band and tread mounting apparatus 300 and a shear band support device 400.

### Mounting of the Rim Inside the Spokes

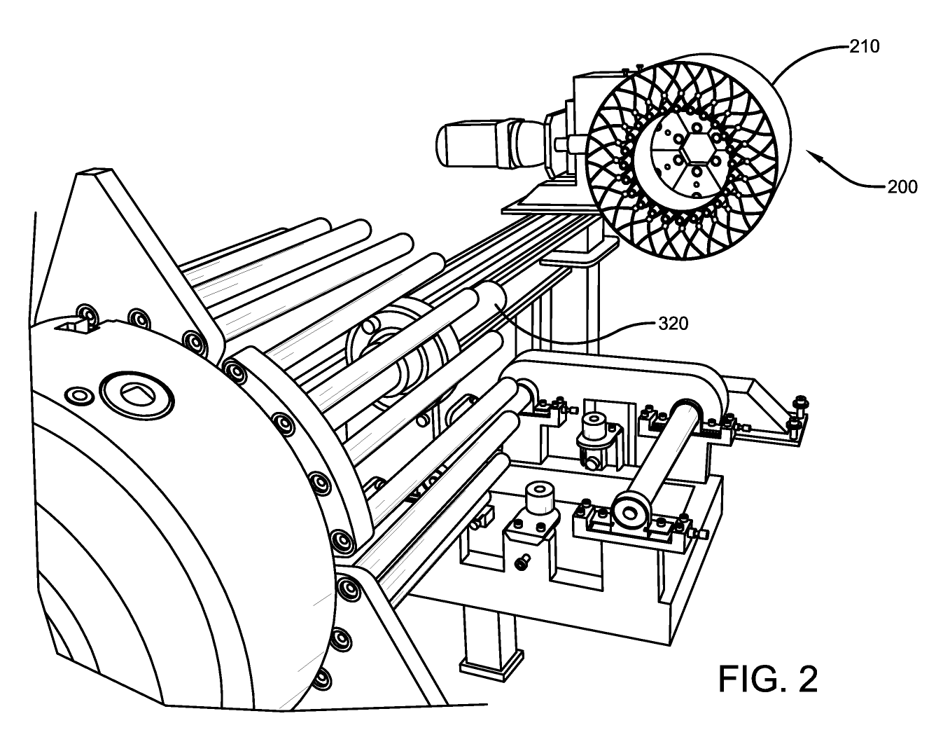

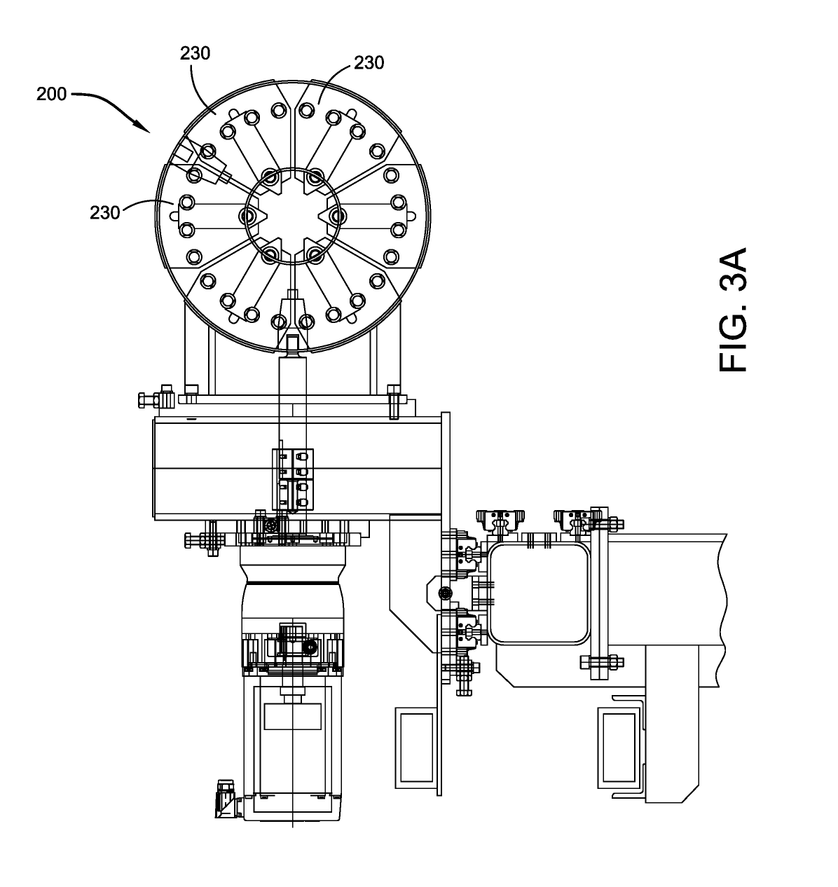

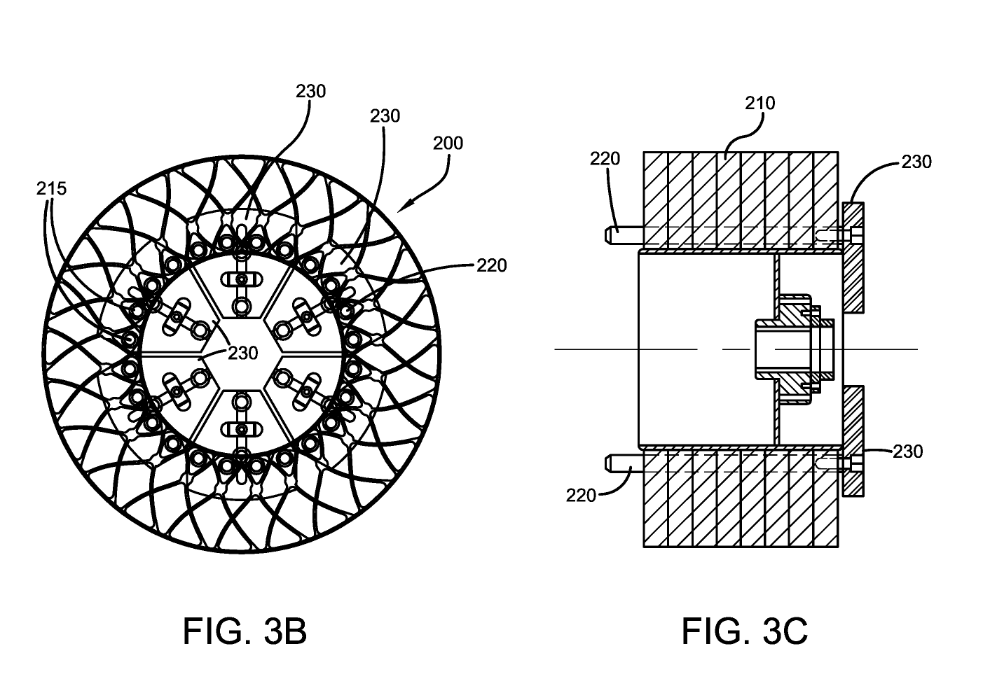

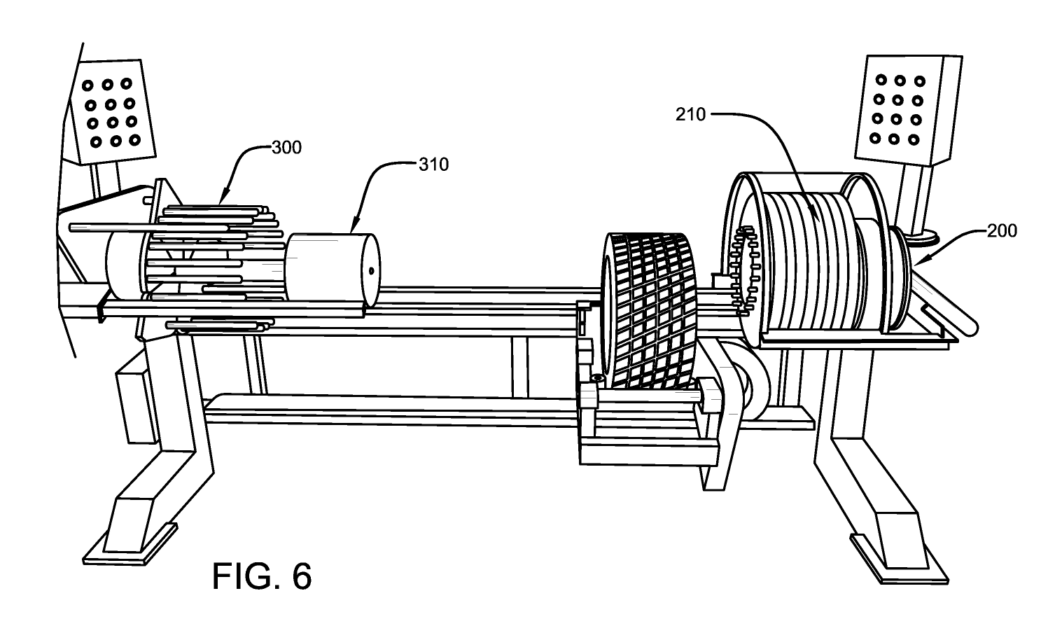

The first step to build a nonpneumatic tire is to mount a plurality of spokes or connecting structures onto a rim 310. In order to accomplish this, the rim 310 is first mounted onto a spindle 320 of the tread mounting apparatus 300 as shown in FIG. 6. The rim mounting apparatus 200 comprises a plurality of mounting plates 230 arranged in a circle. Each mounting plate 230 is received in a jaw 240 of a chuck lathe 250. In this example, there are six mounting plates 230 with each mounting plate being mounted in a jaw 240 of a six-jaw chuck 250. The six-jaw chuck 250 has a spiral gear that meshes with cog teeth on the jaws 240 to move all of the jaws radially inward or radially outward as desired (not shown). Each mounting plate 230 has a plurality of pins 220, wherein all of the mounting plates are arranged so that the mounting pins 220 are arranged in a circle. Next, two or more spoke disks 210 are mounted on the pins 220 of the rim mounting apparatus. As shown in FIG. 2 and FIG. 3B, the inner triangular slots 215 of the spokes are each mounted on a pin 220 of the rim mounting apparatus. Next, glue is applied to the rim. The glue may be a urethane epoxy, or from the cyanoacrylate family such as super glue. Next, the jaws of the six-jaw chuck are expanded radially outward, resulting in the pins 220 moving radially outward. The radially outward movement of the pins 220 results in radial expansion of the inner diameter of the spokes.

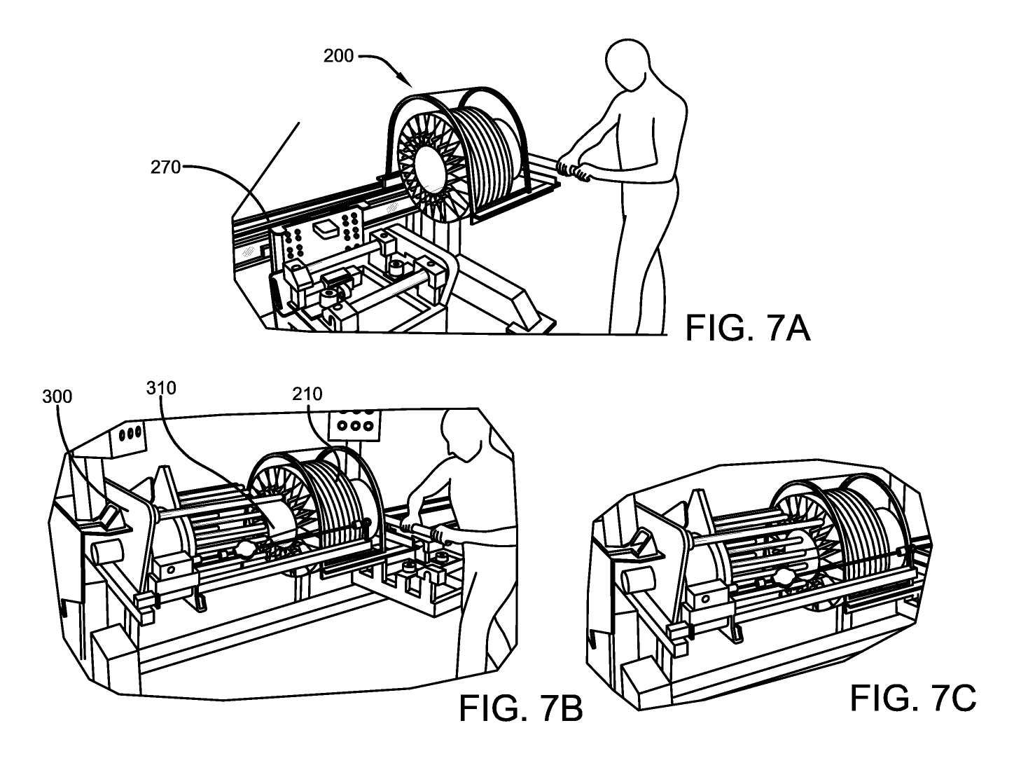

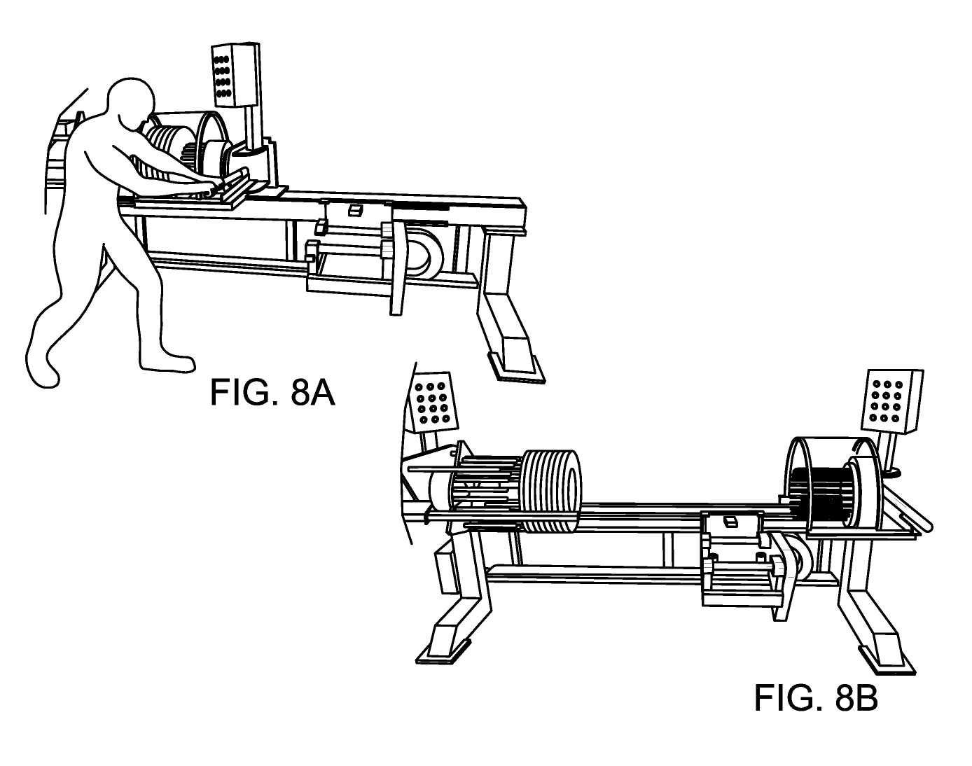

As shown in FIG. 7A, the rim mounting apparatus 200 is then slid to the left on rails 270 towards the tread mounting apparatus 300. The rim mounting apparatus 200 is slid to the left so that the spoke disks 210 are slid over the rim 310, as shown in FIGS. 7B and 7C. Next the jaws are released in order to collapse the pins radially inwards so that the spokes are mounted onto the rim 310 in an interference fit. The rim mounting apparatus is then returned to its home position, leaving the spokes adhered to the rim at the spindle, as shown in FIGS. 8A and 8B. Next the spindle is slowly turned in order to rotate the spoke and rim subassembly in order to keep the glue from pooling.

### Mounting of the Shear Band and Tread Assembly

The next step is to load the shear band and tread subassembly 400 onto the spoke and rim subassembly. The tread and shear band ring is first mounted onto the shear band carriage 500, as shown in FIG. 1. The shear band carriage 500 has rollers 520 which can rotate the tread and shear band when mounted on the carriage. A glue such as cyano-acrylate (super glue) is applied to the inner surface of the shear band. The shear band and tread structure is then rotated slowly by the rollers 520 in order to keep the glue from pooling.

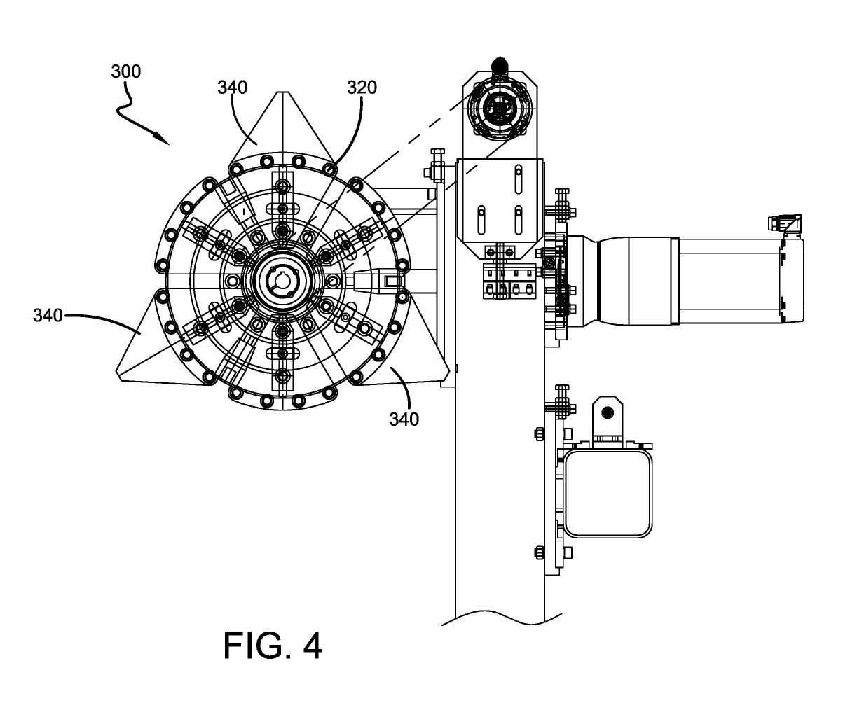

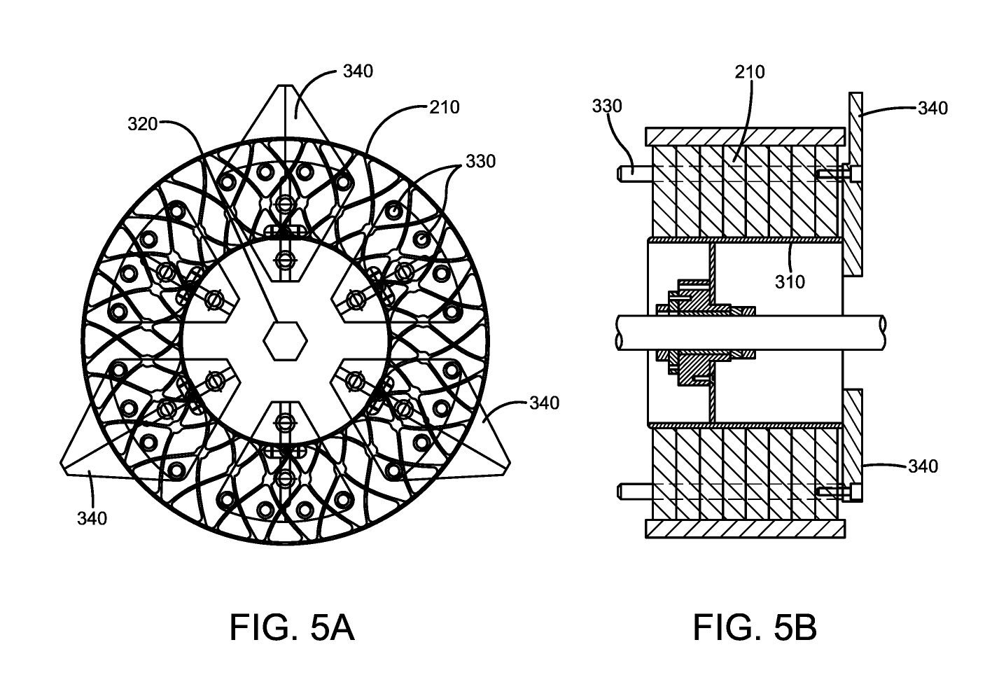

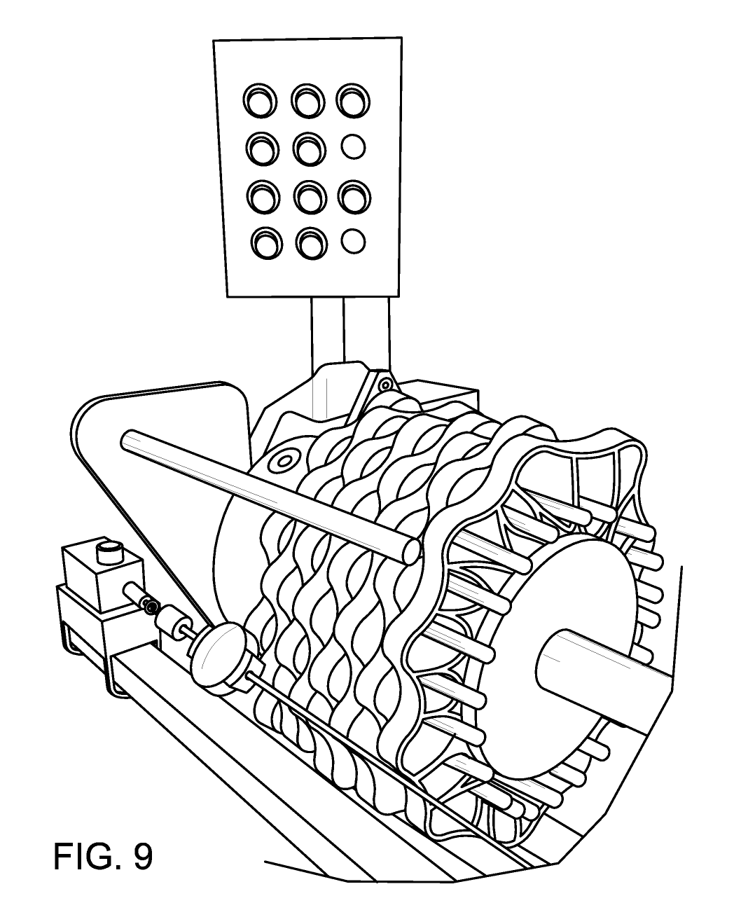

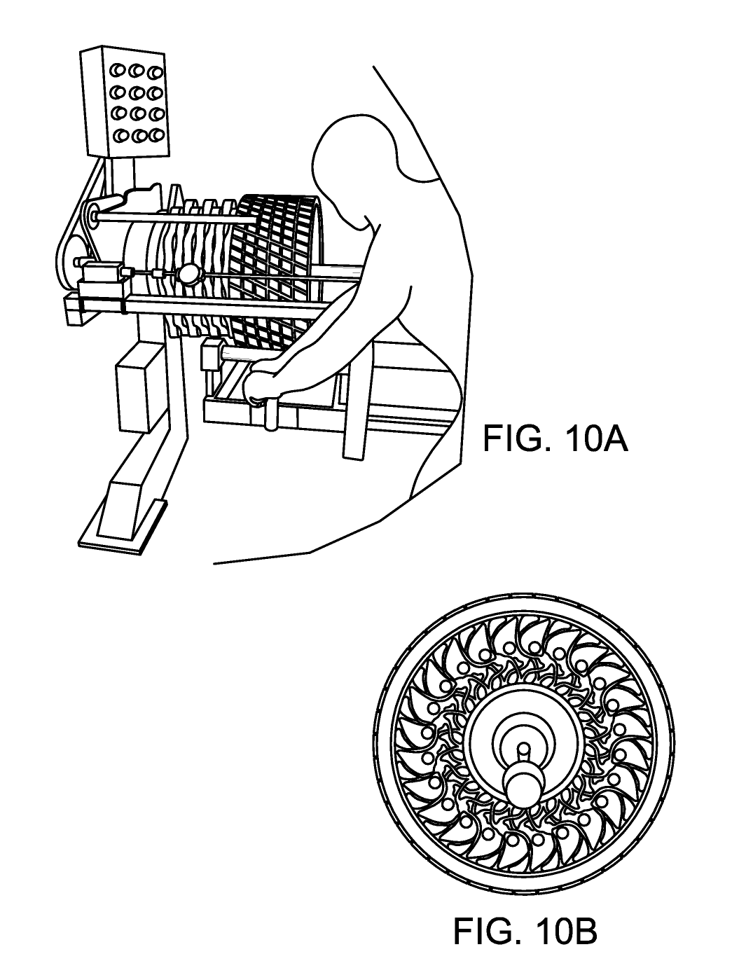

Next, the spoke and rim subassembly is mounted on the tread mounting apparatus 300 so that the outer portion of the spokes are mounted on the mounting pins 330, as shown in FIG. 4 and FIG. 5A. The expansion pins are mounted on mounting plates 320 which are mounted in a jaw of a six-jaw chuck machine. The six-jaw chuck has an internal spiral gear (not shown) that meshes with cog teeth on the jaws to move all of the jaws radially inward or radially outward as desired (not shown). The mounting plates 320 are then moved in their radially inward position, so that the mounting pins are contracted radially inward as shown in FIG. 9. When the mounting pins are contracted radially inward, the shear band and tread is slid over the compressed spoke structure as shown in FIG. 10, forming an interference fit. Next, the mounting plates are moved back to their home position, releasing the tension of the mounting pins on the spoke structure, forming an interference fit between the connecting structures and the shearband. The completed non-pneumatic tire assembly is then slid free of the shearband mounting apparatus along the spindle. The non-pneumatic tire assembly is then slowly rotated while the adhesive cures at room temperature.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for forming a nonpneumatic tire comprising the steps of:
mounting a rim on a spindle;
providing a spoke structure having an inner diameter and an outer diameter;
expanding the inner diameter of the spoke structure and mounting the spoke structure over the rim; and
compressing the outer diameter of the spoke structure and then mounting a tread and shearband assembly over the outer diameter to form a nonpneumatic tire.

2. The method of claim 1 further comprising the steps of applying adhesive to the inner diameter of the spoke structure before mounting the rim.

3. The method of claim 1 further comprising the steps of applying adhesive to the outer diameter of the rim before applying the spoke structure.

4. A method for forming a nonpneumatic tire comprising the steps of:
mounting a rim on a spindle;
providing a plurality of mounting plates wherein each mounting plate has one or more mounting pins, wherein the mounting plates are movable in a radial direction;
providing a spoke structure having an inner diameter and an outer diameter, and mounting the spoke structure on the mounting pins;
expanding the inner diameter of the spoke structure by moving the mounting plates in the radial direction, and mounting the spoke structure over the rim; and
mounting the outer diameter of the spoke structure on compression pins, and then moving the compression pins radially inward while mounting a tread and shearband assembly over the outer diameter to form a nonpneumatic tire.

5. An apparatus for forming a non-pneumatic tire, the apparatus comprising a plurality of mounting plates arranged in a circle, wherein the mounting plates are capable of moving in the radial direction, wherein each mounting plate has a plurality of pins, wherein all of the pins are arranged in a circle.

6. The apparatus of claim 5 further comprising a spindle.

7. The apparatus of claim 6 wherein the spindle is located in the center of the apparatus.

8. The apparatus of claim 5 wherein the mounting plates are moved radially inward.

9. The apparatus of claim 5 wherein the mounting plates are moved radially outward.

10. The apparatus of claim 5 wherein the apparatus is mounted on a rail for traversing in a first direction.
